(19) United States
(12) Patent Application Publication
(10) Pub. No.: US 2009/0307156 A1
(43) Pub. Date: Dec. 10, 2009

(54) METHOD OF STAGING PRODUCT

(76) Inventor: James H. Johnson, JR., Lexington, KY (US)

Correspondence Address: KING & SCHICKLI, PLLC, 247 NORTH BROADWAY, LEXINGTON, KY, 40507, US

(21) Appl. No.: 11/996,662

(22) PCT Filed: Jul. 24, 2006
(86) PCT No.: PCT/US06/28569

§ 371 Date: Jan. 24, 2008

Related U.S. Application Data
(60) Provisional application No. 60/702,476, filed on Jul. 26, 2005.
(60) Provisional application No. 60/763,688, filed on Jan. 31, 2006.
(60) Provisional application No. 60/781,812, filed on Mar. 13, 2006.

(51) Int. Cl. G06Q 90/00

(52) U.S. Cl. 705/500

(57) ABSTRACT

A method for staging product includes the steps of acquiring a site placement right for a product staging structure (FIG. 1) from a retailer, placing the product staging structure at the site adjacent the retailer, marketing space on the product staging structure to a product manufacturer and storing product produced by the product manufacturer in the product staging structure for eventual sale by the retailer.

This application claims the benefit of U.S. Provisional Application Ser. Nos. 60/702,476 filed 26 Jul. 2005, 60/763,688 filed 31 Jan. 2006 and 60/781,812 filed 13 Mar. 2006.

### TECHNICAL FIELD

The present invention relates generally to the storage and outdoor advertising fields and more particularly to a method of staging product for a product vendor.

### BACKGROUND OF THE INVENTION

Many product vendors including particularly but not exclusively limited to dairy and beverage vendors must provide just-in-time delivery services to their high demand retail customers. Typically those retail customers require daily or every other day delivery of products such as milk, beer, soft drinks and sport drinks. It is a significant management challenge to design and develop an efficient delivery schedule to meet retailer demand. Further, transportation costs have recently spiked due to increases in gasoline prices. Unfortunately, expectations are for gasoline and diesel fuel prices and therefore delivery costs continue to trend higher.

The present invention relates to a method for staging product wherein transportation and manpower costs may be reduced dramatically by staging inventory on site at retailer locations. Such an approach also simplifies the development and coordination of delivery schedules.

### SUMMARY OF THE INVENTION

In accordance with the purposes of the present invention as described herein, a method is provided for staging product. The method comprises acquiring a site placement right for a product staging structure from a retailer, placing a product staging structure at the site adjacent the product retailer and marketing space in the product staging structure to a vendor of a particular product sold by the retailer. In addition, the method may include marketing advertising space on the product staging structure. The method may further include sharing with the product retailer a portion of advertising revenue generated by marketing the advertising space on the product staging structure.

In accordance with additional aspects, the method may include advertising the particular product on the product staging structure. Alternatively or in addition the method may include advertising for the retailer on the product staging structure. In addition the method may include storing a particular product from the vendor in the product staging structure for eventual sale by the retailer.

Alternatively, the present business method may be described as comprising the steps of placing the product staging structure at a site adjacent to a retailer and marketing space in the product staging structure to a vendor of a particular product sold by that retailer. The method may include owning the product staging structure or selling the product staging structure to the retailer or the vendor. In addition, the method may include customizing the space in the product staging structure to meet the needs of the vendor. Further, the method may include customizing the exterior of the staging structure to incorporate the trade dress of the retailer or the vendor as desired.

Still further, the method may include the providing of climate control for the space in the staging structure. The method may also include rotating advertising provided on the staging structure and illuminating that advertising.

Still further, the method may include constructing the staging structure from modular building materials and in some instances even anchoring the staging structure to the ground. For certain applications the method may also include removing the staging structure after a predetermined period of time and even reusing the staging structure at another location. In addition, the staging structure may be provided with a decorative roof cap. Further, a portion of the space in the staging structure may be customized to meet the needs of the retailer. Still further, the space may be partitioned into multiple product staging areas and the method may include marketing the multiple product staging areas to different product vendors.

In accordance with the additional aspect of the present invention the method may comprise contracting with a vendor to stage the promoted product marketed by the vendor and placing a product staging structure adjacent a retailer of that product. Alternatively, the method may also be defined as comprising contracting with a vendor to stage a promoted brand of beverage, placing a product staging structure adjacent a retailer of that brand of beverage and collecting revenue from the vendor for staging and promoting the brand of beverage.

In the following description there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention.

Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention, and together with the description serves to explain certain principles of the invention. In the drawing:

FIG. 1 is a perspective view of a storage structure provided to a customer through the method of the present invention; and

FIG. 2 is a schematical end elevational view of a storage structure through the open end doors.

Reference will now be made in detail to the present preferred embodiment of the invention, an example of which is illustrated in the accompanying drawing.

### DETAILED DESCRIPTION OF THE INVENTION

As noted above, the present business method relates to product staging. That method may be generally and broadly described as including the steps of acquiring a site placement right for a product staging structure from a retailer, placing the product staging structure at the site adjacent the retailer and marketing space in the product staging structure to a vendor of a particular product sold by the retailer. The method may also include storing the particular product of the vendor in the product staging structure for eventual sale by the retailer. For purposes of interpretation of this document, the term “vendor” includes a wholesaler, distributor, manufacturer or any entity having an interest in selling or marketing a particular product. Still further, the method may also include the step of marketing advertising space on the product staging structure. In addition the method may include the step of sharing revenue generated by marketing advertising space on the product staging structure with the retailer or vendor.

Alternatively, the method of the present invention may be described as comprising the steps of placing a product staging structure at a site adjacent a retailer and marketing space in the product staging structure to a vendor of a particular product sold by the retailer. This method may further include the step of marketing advertising space on the product staging structure and even the step of sharing with the retailer or vendor revenue generated by marketing advertising space on the product staging structure. In yet another alternative, the method may comprise the steps of contracting with a vendor to stage and promote a product marketed by the vendor and placing a product staging structure adjacent a retailer of the product. Still further, the method may comprise the steps of contracting with a vendor to stage and promote a brand of beverage, placing a product staging structure adjacent a retailer of that brand of beverage and collecting revenue from said vendor for staging and promoting that brand of beverage. The beverage may include but is not limited to soft drinks, sports drinks and beer.

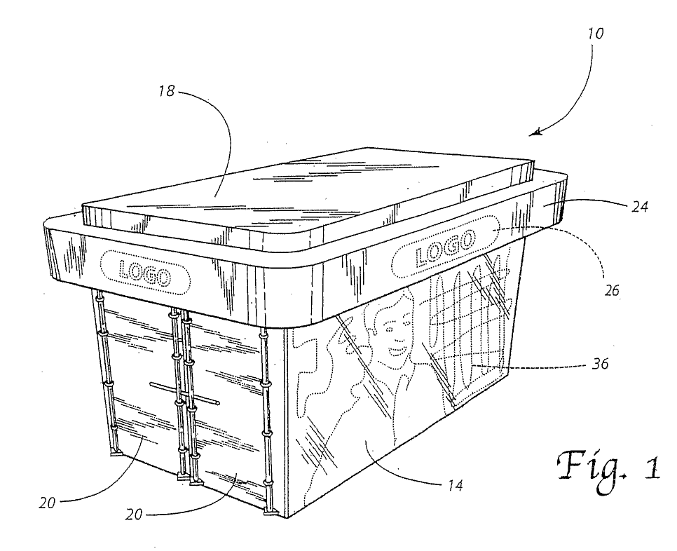

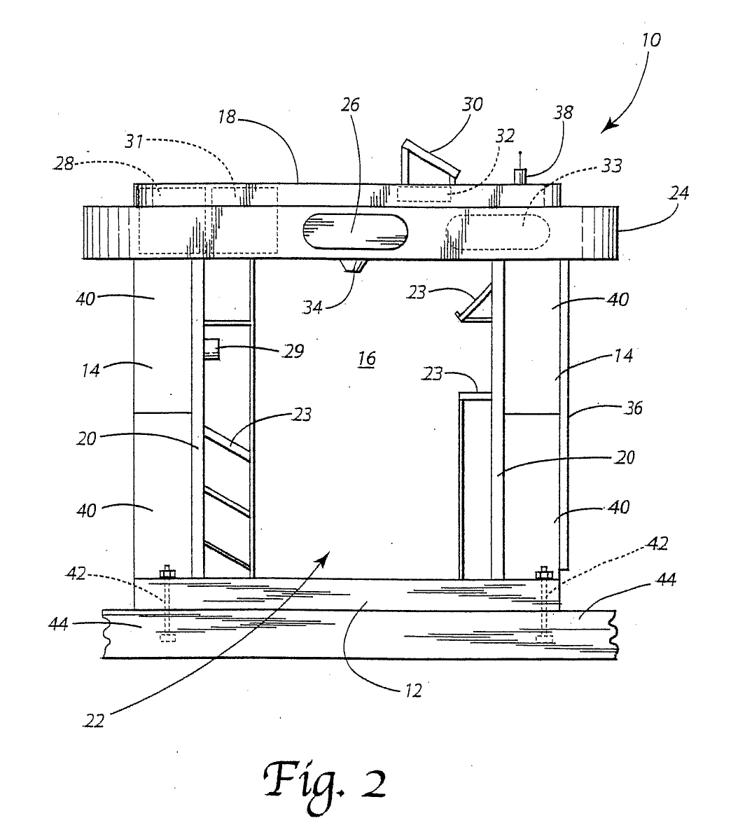

One possible construction of a storage/staging structure a/k/a integrated advertising and storage structure or outbuilding 10 is illustrated in FIGS. 1-2. More specifically the storage structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior storage space 22. That storage space 22 may be customized to meet the vendor's needs including particular rack, shelving, partitioning layouts (note shelves 23) as required or desired by the vendor for purposes of inventory storage and control. The interior customization may, of course, be tailored to integrate with inventory control technology such as bar coding.

Similarly, the exterior of the storage structure 10 may be customized to match the trade dress and/or architectural features of the retailer's main building near which the storage structure 10 may be placed into service. Thus, for example, the storage structure 10 may include a decorative roof cap 24 sized and shaped to customer specifications. The roof cap 24 may include customer advertising, trade dress or logo 26 if desired and/or as allowed by local regulations.

The storage structure 10 may also be equipped with various electrical and/or mechanical systems. For example, a climate control unit such as an air conditioner, refrigerator, freezer, humidifier or dehumidifier 28 may be provided on the storage structure 10 in order to provide climate control of the storage space 22 within the storage structure. Accordingly, products such as perishable food, dairy products, soft drinks and beer may be maintained at the desired temperatures even in hot and humid environments.

In addition, the storage structure 10 may be equipped with a solar panel 30 and cooperating battery 32 to store energy for powering an internal lighting system 34 for illuminating the storage space 22 or illuminating advertising 36 on the side wall 14, end wall 16 or other exterior component of the storage structure 10. That advertising 36 may comprise a stretched banner material and it may be front lit or back lit as desired. If desired, power for all the electrical and mechanical components of the storage structure 10 may be provided through an electrical circuit box 29 carried on the housing 10 and connected to the lines of the local electric utility supplier. Alternatively, the housing 10 may carry an electric generator 31. In one possible embodiment, the generator 31 may be driven by natural gas and connected to the underground supply line of the local natural gas provider. In another possible embodiment, the generator 31 may be driven by propane and the structure may further include a propane storage tank 33 for supplying propane to the generator. Of course, that propane storage tank 33 could also be provided underground. In yet another alternative, the electric generator is powered by a fuel cell.

Still further, the storage structure 10 may incorporate a radio transmitter 38 for the transmission of short range advertisements respecting products displayed in the advertising 36 appearing on the exterior surface of the storage structure 10. A particularly effective advertising combination is the use of a backlit digital graphic advertising banner 36 in conjunction with local transmission radio advertising providing details of the particular product. This is particularly effective when advertising a product that is sold at the customer's place of business.

The storage structure 10 may be constructed from any appropriate material. The storage structure 10 could be constructed in the manner of a standard trailer or box truck and may or may not include additional architectural details. The storage structure 10 may be constructed, for example, from modular building materials such as prefabricated panels 40 of the type shown and described in, for example, U.S. Pat. Nos. 6,279,287 to Meadows, 5,373,678 to Hesser and 6,119,427 to Wyman et al. Such modular panels typically incorporate a core of thermal insulating material sandwiched between metal or plastic sheathing. Such a construction provides both efficient and effective control of the temperature and humidity of the environment in the internal storage space 22 and excellent inclement weather durability for a long, low-maintenance service life.

Structures 10 constructed from such modular building panels 40 are also characterized by high strength and will resist high winds and maintain a weather-tight enclosure to protect products held in the storage space 22 from inclement weather. In fact, such structures may be easily anchored to the ground such as by means of cooperating nut and bolt anchors 42 where the bolt is held in an underlying poured concrete pad 44. The modular panels 40 also allow the storage structure 10 to be quickly and easily erected and subsequently removed in a minimal amount of time while producing a minimum of mess.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the advertising 36 may comprise the direct application of graphics to the panels 40 of the structure 10 and down lighting from a light source 42 in the roof cap 24 to illuminate those graphics. The structure 10 could also include an electronic display system such as a plasma monitor, liquid crystal display, a rotating sign assembly such as disclosed in U.S. Pat. No. 4,021,946, and electronic message board or the like to display advertising 36.

The embodiments were chosen and described to provide the best illustrations of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1.) A business method, comprising:
acquiring a site placement right for a product staging structure from a retailer;
placing said product staging structure at said site adjacent said retailer; and
marketing space in said product staging structure to a vendor of a particular product sold by said retailer;

2.) The method of claim 1, including marketing advertising space on said product staging structure.

3.) The method of claim 1, including advertising said particular product on said product staging structure.

4.) The method of claim 1, including advertising for said retailer on said product staging structure.

5.) The method of claim 1, including storing said particular product from said vendor in said product staging structure for eventual sale by said retailer.

6.) The method of claim 2, including sharing revenue generated by marketing advertising space on said product staging structure with one of said retailer and said vendor.

7.) A business method, comprising:
placing a product staging structure at a site adjacent a retailer; and
marketing space in said product staging structure to a vendor of a particular product sold by said retailer.

8.) The method of claim 7, including marketing advertising space on said product staging structure.

9.) The method of claim 8, including sharing revenue generated by marketing advertising space on said product staging structure with one of said vendor said retailer.

10.) The method of claim 7, including advertising said particular product on said product staging structure.

11.) The method of claim 7, including advertising for said retailer on said product staging structure.

12.) The method of claim 7, including storing said particular product from said vendor in said product staging structure for eventual sale by said retailer.

13.) The method of claim 7, including owning said product staging structure.

14.) The method of claim 7, including selling said product staging structure to said retailer.

15.) The method of claim 7, including selling said product staging structure to said vendor.

16.) The method of claim 7 including customizing said space to meet needs of said vendor.

17.) The method of claim 7, including customizing an exterior of said staging structure to incorporate trade dress of said retailer.

18.) The method of claim 7, including customizing an exterior of said staging structure to incorporate trade dress of said vendor.

19.) The method of claim 7 including providing climate control for said space in said staging structure.

20.) The method of claim 7, further including rotating advertising provided on said staging structure.

21.) The method of claim 7, further including illuminating advertising provided on said staging structure.

22.) The method of claim 7, further including constructing said staging structure from modular building materials.

23.) The method of claim 7, further including anchoring said staging structure to the ground.

24.) The method of claim 7, including removing said staging structure after a predetermined period of time.

25.) The method of claim 24, including reusing said staging structure at another location.

26.) The method of claim 7, including providing said staging structure with a decorative roof cap.

27.) The method of claim 7, including customizing at least a portion of said space in said staging structure to meet needs of said product retailer.

28.) The method of claim 7, including partitioning said space into multiple product staging areas and marketing said multiple product staging areas to different product vendors.
